(19) United States
(12) Patent Application Publication
(10) Pub. No.: US 2013/0163185 A1
(43) Pub. Date: Jun. 27, 2013

(54) DATA CENTER DOCKING STATION AND CARTRIDGE

(71) Applicants: Stephan W. Gilges, Seattle, WA (US); Christian L. Belady, Mercer Island, WA (US); David Thomas Gauthier, Seattle, WA (US); Mark E. Shaw, Sammamish, WA (US); Steven Solomon, Bellevue, WA (US)

(72) Inventors: Stephan W. Gilges, Seattle, WA (US); Christian L. Belady, Mercer Island, WA (US); David Thomas Gauthier, Seattle, WA (US); Mark E. Shaw, Sammamish, WA (US); Steven Solomon, Bellevue, WA (US)

(73) Assignee: MICROSOFT CORPORATION, Redmond, WA (US)

(21) Appl. No.: 13/334,021

(22) Filed: Dec. 21, 2011

(51) Int. Cl. G06F 1/16; B23P 6/00

(52) U.S. Cl. 361/679.41; 29/402.08

(57) ABSTRACT

A data center may be built from docking stations, and from removable and replaceable IT cartridges. In one example, a docking station is built that provides cooling capability, and other support capability, for IT equipment. An IT cartridge is coupled to the docking station, thereby allowing the IT equipment in the cartridge to receive cooling and other support from the docking station, without the cartridge having any cooling infrastructure (or without having a substantial cooling infrastructure). Since IT equipment may have a shorter useful life than cooling equipment (or other non-IT equipment), when the IT equipment has reached the end of its useful life, the IT cartridge can be retired, and replaced with a new IT cartridge, thereby allowing the longer-lived equipment in the docking station to be easily reused with new IT equipment.

### BACKGROUND

A data center is a facility that houses servers and other computing equipment for large-scale applications. For example, a data center may house the computers that act as web servers, file servers, e-commerce servers, search engines, databases, etc. In many cases, data centers are built from modular components. Modularization of data center components allows data centers to be made larger or smaller, depending on the demands being placed on the center. Modularization also allows a data center to be assembled in one location and deployed at another location.

A data center module may take the form of a container that houses, among other things, Information Technology (IT) equipment (such as servers, routers, etc.) and cooling equipment. One problem with this type of modularization is that the IT equipment and the cooling equipment typically have different useful life spans—often fifteen years for the cooling equipment, but three years for the IT equipment. The relatively short useful life of the IT equipment is often a limitation on how long a module can be used. Once the IT equipment has become obsolete, the module is often retired, including the mechanical assets relating to cooling whose useful life has not been exhausted. Similar issues may apply to electrical power equipment, fire suppression equipment, or equipment that performs various other functions and whose useful life has not been exhausted. Disposing of mechanical assets whose useful life has not been exhausted is expensive and wasteful.

### SUMMARY

A data center may be constructed from modules in a way that decouples the IT equipment from other mechanical assets, such as the cooling equipment. IT equipment, such as servers, routers, etc., may be placed in an IT cartridge, without supporting equipment such as cooling equipment, electrical equipment and fire suppression equipment. In one example, the IT cartridge may take the form of a shipping container, which allows the IT cartridge to be transported easily from one place to another. A docking station may be built, which contains supporting equipment. For example, the docking station may be a building or consolidated equipment arrangement that contains air conditioners, electrical equipment and fire-suppression equipment. The IT cartridge may be coupled to the docking station. In the example where the docking station is a building and the IT cartridge is a shipping container, coupling the IT cartridge to the docking station may involve driving the shipping containers into bays in the building, and plugging the IT equipment into electrical and network connections provided by the building.

The physical structure of the docking station may be such that the IT cartridge can easily be connected and removed. For example, the cooling equipment in the docking station may be arranged in such a way that it can perform the cooling function for the IT equipment in the cartridge without interfering with the cartridge's removal. In this way, when the IT equipment in the cartridge wears out or becomes obsolete, the IT cartridge can be removed from the docking station, and a new IT cartridge can be inserted. Thus the longer-lived mechanical assets in the docking station (e.g., cooling equipment, such as fans and mechanical refrigeration devices) may continue to be used throughout their useful life, even when the shorter-lived IT equipment is refreshed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of an example docking station coupled to an IT cartridge.

FIG. 2 is a perspective view of an example scenario in which an IT cartridge may be coupled to a docking station.

FIG. 3 is a perspective view of an example docking station.

FIG. 4 is a cutaway view of the docking station shown in FIG. 3.

FIG. 5 is a cross sectional elevation view of the docking station shown in FIG. 1.

FIG. 6 is a cross sectional elevation view of an example apparatus that may be used to couple a docking station with an IT cartridge.

FIG. 7 is a flow diagram of an example process of using IT cartridges with a docking station.

FIG. 8 shows example equipment that may be used with aspects of the subject matter herein.

### DETAILED DESCRIPTION

Data centers are facilities that contain servers and other equipment. Data centers may be used to perform various functions, such as hosting web servers, hosting databases, providing back-end support for finance or e-commerce, or any other function that can be performed by computer. Data centers contain large numbers of servers and other IT equipment, as well as mechanical support for that equipment. Mechanical support may include cooling equipment, fire suppression equipment, utility power, backup power, data connectivity, and any other infrastructure that is used by the IT equipment.

Data centers are often modular, in the sense that the center is built out of modules that contain the equipment to perform various different functions. Modularization makes a data center scalable, since the capacity of the data center can be increased or reduced by adding or removing modules. Additionally, modularization allows the components for the data center to be assembled in one place and deployed in another place, since the modules may be relatively easy to move. In one example, the modules are built in shipping containers, since such containers can easily be carried over land or water nearly anywhere in the world.

There are various different ways to modularize a data center. One way to modularize a data center is to build self-contained modules that include electrical equipment, IT equipment, cooling equipment, fire suppression equipment, and any other equipment that is involved in operating a data center. Each such module could operate as a data center on its own. Another way to modularize a data center is to build various function modules—e.g., an IT module that houses servers and other IT equipment, a cooling module that houses refrigeration equipment, a fire suppression module that houses fire suppression equipment, an electrical module that houses distribution panels, Uninterruptable Power Supplies (UPSs), transfer switches, backup generators, etc. These modules can be connected to each other, thereby allowing a data center to be built out of function modules. In a simple example, an IT module that contains servers, routers, disk drives, etc., can be connected to a cooling module that contains the refrigeration equipment to produce chilled water. The IT module can then be connected to the cooling module, so that the cooling module keeps the equipment in the IT module cool.

One issue that arises when modules implement separate functions is that an IT module often has to include equipment to support its ability to receive another function from one of the functional modules. For example, a cooling module might house the refrigeration equipment that produces chilled water. But, in order for an IT module to be cooled by that refrigeration module, it may have to have piping to receive and circulate the chilled water, radiators to convert the chilled water in to cold air, and fans to distribute the cold air to the severs. Thus, even when the cooling function has been nominally segregated in a separate module, an IT module often has a significant amount of cooling-related hardware in order to use the cooling function provided by another module. In other words, in the function module paradigm, separation of function between the modules is often incomplete.

A problem that arises when equipment to support different functions is in the same module is that the useful life of equipment is often characteristic of the function that the equipment supports. In a simple example, IT equipment may have a three-year lifecycle, while refrigeration equipment may have a fifteen-year lifecycle. Putting refrigeration equipment and IT equipment in the same module presents a complication, because—when it is time to retire the IT equipment—the cooling equipment may still have many years of useful life ahead. Therefore, either the refrigeration equipment has to be reused and repurposed for a new IT module with new IT equipment, or the refrigeration equipment has to be discarded. Either disposition of the refrigeration equipment is an expense.

The subject matter described herein may be used to build a modularized data center on a docking station paradigm. A docking station may provide various support functions for IT equipment—e.g., cooling, fire suppression, power distribution, backup power, etc. An IT cartridge may contain IT equipment, such as servers, disk drives, routers, etc. The IT cartridge may be couplable with the docking station, so that the combination of a docking station and one or more IT cartridges may be able to function as a working data center. In one example, the docking station may take the form of a building with bays that can receive the IT cartridges. Moreover, in one example, each IT cartridge is a shipping container that contains IT equipment, and that can be driven into the bays. The IT cartridges may contain little or no non-IT equipment. In this way, the equipment in the cartridge generally follows an IT equipment lifecycle, thereby eliminating or reducing the amount of equipment that has to be disposed of early, or that has to be repurposed, when the IT equipment in the cartridge is retired at the end of its useful life.

There are various ways to connect an IT cartridge to a docking station. One way, as mentioned above, is to have each IT cartridge be a container that can be driven into the docking station. In another example, the docking station may have an opening, or other type of connection point, that allows IT cartridge to be brought next to the docking station, and to receive support such as cooling, fire suppression, power, etc., from the docking station without having to be brought inside the docking station. In one example, a rubber seal may be provided at the connection point, in order to keep both the inside of the docking station and the inside of the cartridge dry, even when the cartridge is not fully brought inside the docking station.

It is noted that a system in which the IT cartridge has little or no cooling infrastructure (or other non-IT infrastructure) is different from, and is not an obvious variant of, an IT module that contains substantial mechanical support to receive support functions from another module. In the former case, retirement of the IT cartridge leads to little or no loss of the useful life of non-IT equipment. In the latter case, there may be substantial non-IT equipment that has to be repurposed or discarded when the IT module is retired. For example, a scenario in which an IT cartridge can be driven into a docking station, where the docking station has equipment to cool whatever is inside the docking station, is different from, and is not an obvious variant of, an IT module that has chilled water pipes, radiators, fans, etc., to cool the air using chilled water provided by another module. In the later case, the water pipes, radiators, fans, etc., represent a significant investment in non-IT equipment (cooling equipment) that would have to be disposed of or repurposed when the IT module is retired. Moreover, a docking station that receives a cartridge that contains the IT equipment for use in a data center is not the same as, and is not an obvious variant of, a laptop docking station. In the case of a laptop, a detachable docking station helps the laptop to be used effectively in both mobile and non-mobile settings. Moreover, the docking station—being a form of IT equipment itself—often has roughly the same useful lifespan as the laptop. In the case of a data center docking station, the docking station might exist not so much to facilitate mobility as to facilitate disposal or retirement of the IT equipment without also disposing of longer-lived cooling equipment, or other longer-lived equipment.

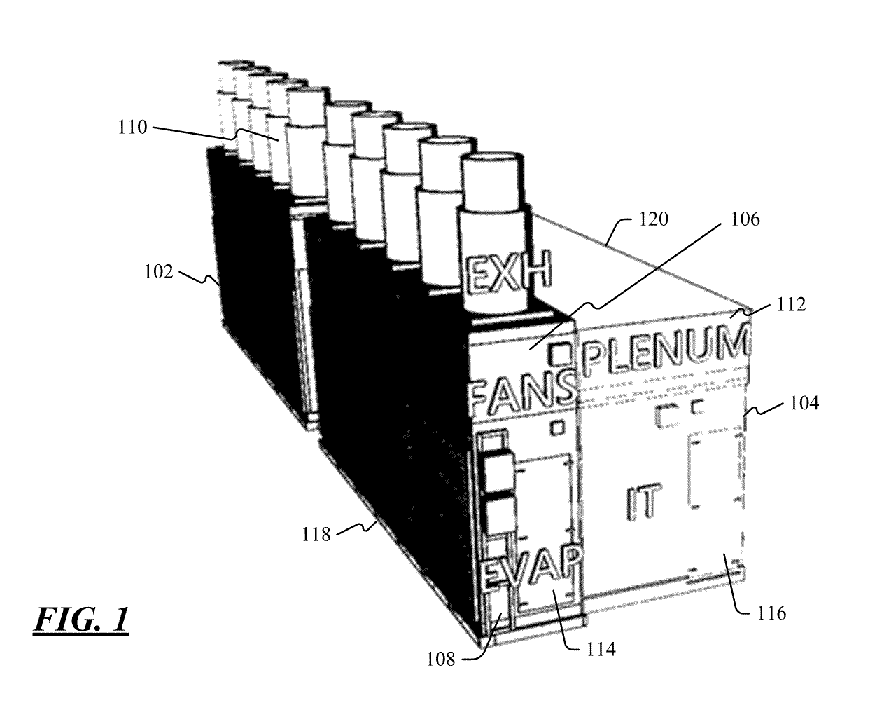

Turning now to the drawings, FIG. 1 shows a perspective view of an example docking station 102 coupled to an IT cartridge 104. Docking station 102 may provide cooling, and other support functions, for IT equipment. In order to provide cooling, docking station may have fans 106, a cooling mechanism such as evaporative cooler 108, and exhaust vents 110. IT cartridge 104 may have a plenum 112 that connects with the intake and/or outflow area of fans 106, so that fans 106 can push or pull air through plenum 112, thereby causing air to pass over the equipment in IT cartridge 104. The equipment in IT cartridge may comprise servers, disk drives, routers, or any other type of equipment. As described above, IT cartridge 104 may have little or no cooling infrastructure. (The servers themselves might have fans inside them, but the overall cartridge might lack any additional cooling infrastructure.) The structure of docking station 102, and the arrangement of equipment in docking station 102, may be such that the cooling equipment in docking station 102 can cool the IT equipment in IT cartridge 104 without pipes, radiators, etc., having to be installed in IT cartridge 104. For example, the IT equipment in IT cartridge 104 may be cooled solely by the action of fans 106 and cooler 108. Docking station 102 and IT cartridge 104 may have outer shells 118 and 120, respectively. In the example in which a docking station or cartridge is made out of a shipping container, the walls of a shipping container constitute the outer shell, although the outer shell could take any appropriate form. It is noted that, in order to allow servicing of docking station 102 and IT cartridge 104, these components may have access entry doors. Doors 114 and 116 are shown.

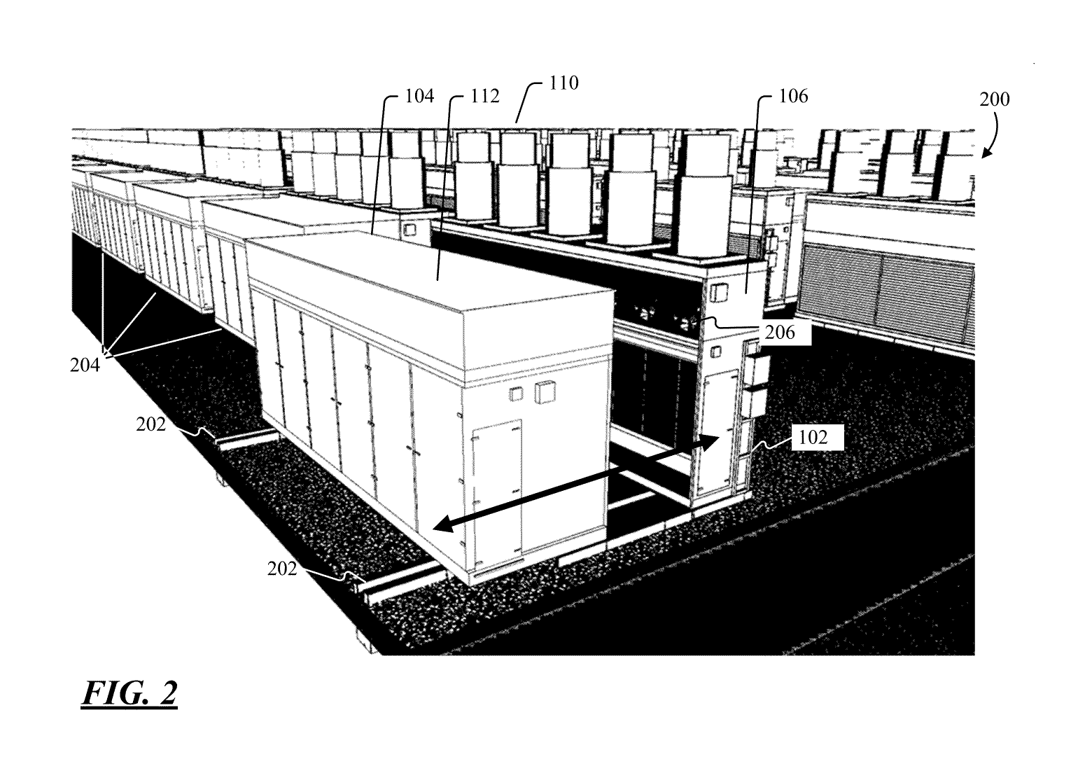

FIG. 2 shows a perspective view of an example scenario in which an IT cartridge 104 may be couplable to a docking station 102. As can be seen, docking station 102 comprises cooling equipment including fans 106 and exhaust vents 110, which allows docking station 102 to provide cooling for an IT cartridge. Fans 106 are positioned in docking station 102 in such a way as to allow fans 106 to push or pull air into plenum 112 of IT cartridge 104. (IT cartridge 104 may have any appropriate IT equipment, such as the servers, disk drives, routers, etc., discussed above in connection with FIG. 1.) In order to allow IT cartridge 104 to be coupled to docking station 102, IT cartridge 104 may be connected by sliding on one or more tracks 202, thereby allowing IT cartridge 104 to slide along the track toward, or away from, docking station 102. When IT cartridge 104 slides toward docking station 102 so as to abut docking station 102, there is sufficiently little space for air to escape between docking station 102 and IT cartridge 104, thereby allowing the air moved by fans 106 to cool IT cartridge 104 without escaping. Docking station 102 may have an opening 206, which detachably receives the IT cartridge, and which allows air to pass from fans 106 into a plenum of the IT cartridge.

It is noted that the docking station 102 shown in FIG. 2 may be part of a cluster of docking stations. Thus, a plurality of docking station/IT cartridge pairs 204 are shown in close proximity to docking station 102. In one example, an entity may operate a cluster containing a plurality of docking stations that provide cooling support (and, possibly, other support). IT cartridges may be attached to those docking stations, thereby allowing several IT cartridges to operate at a single location. Such a cluster of docking stations (with or without IT cartridges) may be referred to as a data center; the plurality of docking stations shown in FIG. 2 (with or without coupled IT cartridges) is an example of a data center 200.

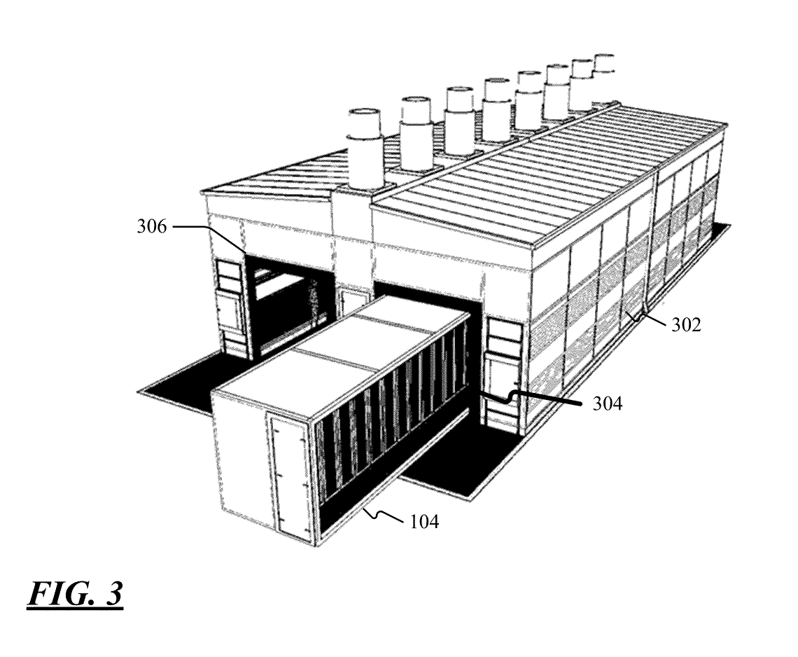

FIG. 3 shows an example docking station 302. Docking station 302, in this example, takes the form of a building having a plurality of bays 304 and 306. IT cartridge 104 may be insertable into or removable from one of the bays. In the example shown, IT cartridge 104 is inserted into bay 304. In the case in which IT cartridge 104 can be attached to a motor vehicle (e.g., in the example in which IT cartridge 104 is a shipping container), IT cartridge 104 can be inserted into a bay by using a truck to drive IT cartridge 104 into the bay.

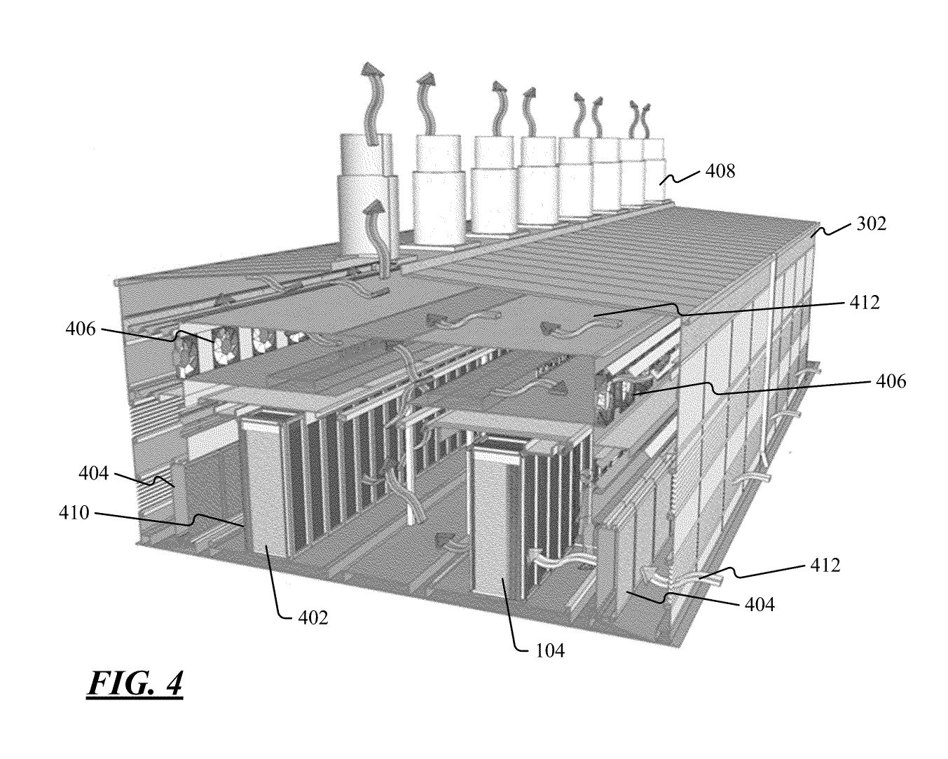

FIG. 4 shows a cutaway view of docking station 302. In the example shown, docking station 302 has received IT cartridges 104 and 402. (In order to show the contents of docking station 302 and the contents of the IT cartridges more clearly, the shell of each IT cartridge, such as the outer walls of a shipping container, is not shown in the figure.) Docking station 302 has cooling apparatus 404 which produce cold air and/or water, and fans 406 which circulate the cold produced by cooling apparatus 404. Docking station 302 also has exhaust vents 408, which allow heat produced by the operation of IT equipment to escape. In the example shown, the contents of IT cartridges 104 and 402 may be racks of servers, disks, routers, etc. (Numeral 410 points to an example rack, which may be one of the racks in IT cartridge 402. For simplicity in the drawing, only one example rack has been pointed to by numeral 410, but similarly drawn structures in FIG. 4 may be understood to be racks.) Arrows 412 show an example flow of air throughout docking station 302. As can be seen, the equipment (such as the rack pointed to by numeral 410) can be cooled by the cooling apparatus 404 and fans 406 of docking station 302, without the use of cooling distribution mechanisms inside IT cartridges 104 and 402. (Although only two example arrows are pointed to in FIG. 4, it will be understood that arrows 412 refers to all of the arrows shown in FIG. 4. All such arrows show an example flow of air.)

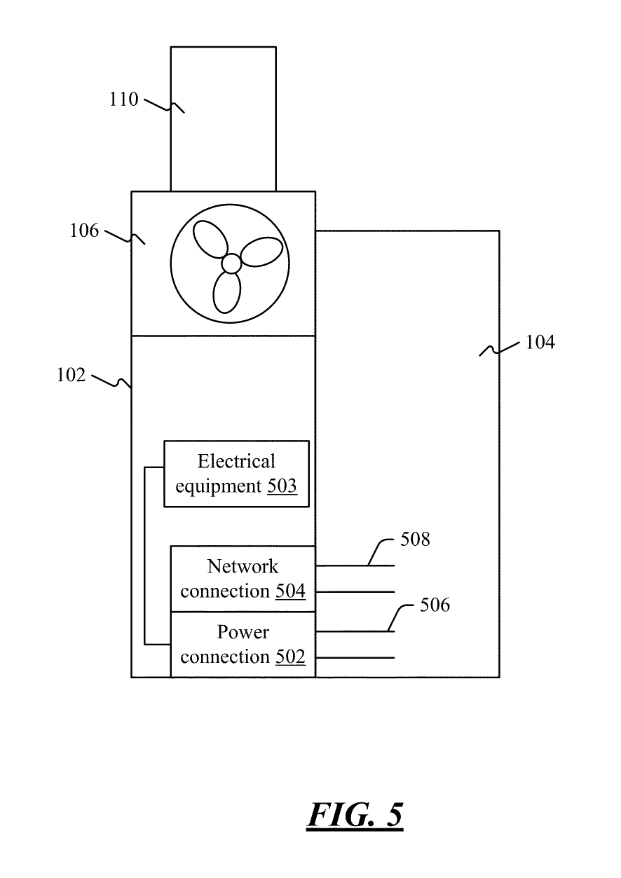

FIG. 5 is a cutaway view of the docking station 102 shown in FIG. 1. As in FIG. 1, the view of docking station 102 that is shown in FIG. 5 includes fans 106, and exhaust vents 110. The fans and exhaust vents help to cool IT cartridge 104, which—in the example shown in FIG. 1—is coupled with docking station 102. In FIG. 5, it can be seen that IT cartridge 104 receives power and/or network connectivity from docking station 102. In particular, docking station 102 has a power connection 502. In one example, power connection 502 is connected directly to utility power. In another example, power connection 502 is connected to both utility power and backup on-site generator power through a set of transfer switches and/or Uninterruptable Power Supplies (UPSs), thereby allowing loads within IT cartridge 104 to continue receiving power even if the utility power fails. (The generators, transfer switches, UPSs, etc., referred to above may be referred to collectively as “electrical equipment” 503, or “electrical-power-providing equipment”. Power connection 502 may be connected to, and served by, electrical equipment 503.) IT cartridge 104 may have a power cord 506, which is plugged into power connection 502. Similarly, docking station 102 may have a network connection 504 (e.g., a fiber port that connects to an Internet Service Provider (ISP)). IT cartridge 104 may have a data cable 508 (e.g., fiber, coax, etc.), which connects to network connection 504, and allows the equipment in IT cartridge 104 to receive network connectivity. IT cartridge may have electrical distribution equipment (e.g., distribution panels, power strips, outlets, etc.) and/or data distribution equipment (e.g., routers, multiplexers, etc.). These pieces of distribution equipment allow the IT equipment in IT cartridge 104 to receive the power provided through power connection 502 and the data connectivity provided through network connection 504. Connections may be made through the mechanisms described above, or through any other appropriate mechanisms (e.g., a bus bar, a blind mate, etc.).

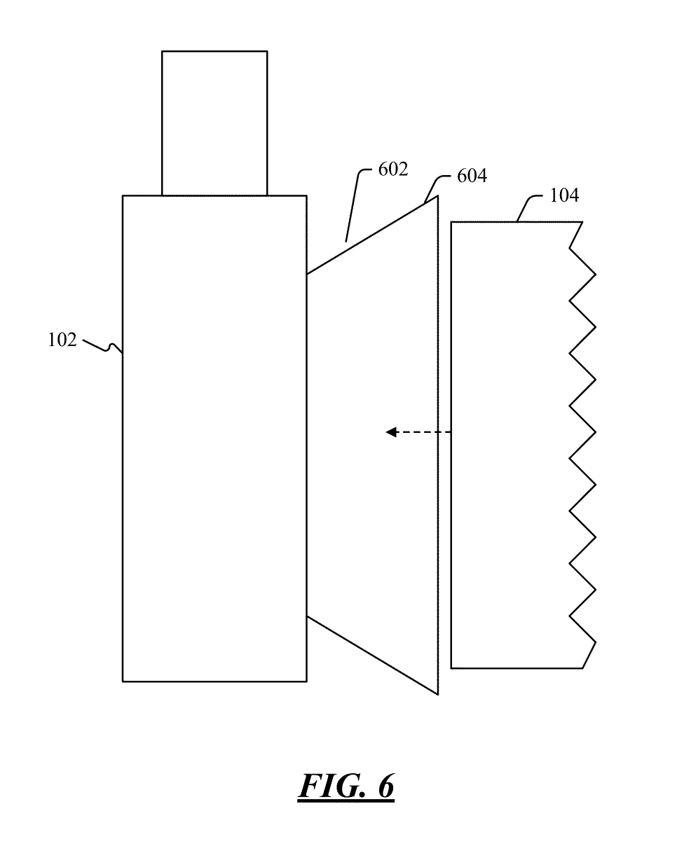

FIG. 6 shows an example apparatus that may be used to couple a docking station with an IT cartridge. Docking stations, and their points of connection with IT cartridges, may be located outdoors, and thus may be exposed to the elements. In order to prevent the equipment in an IT cartridge (or the equipment in a docking station) from being damaged by moisture, wind, etc., a mechanism may be provided that keeps these weather elements from seeping in through the connection point between a docking station and an IT cartridge. Thus, FIG. 6 shows docking station 102 and IT cartridge 104, with an example of such a mechanism in use. A rubber sleeve 602 may be attached to docking station 102 at its expected point of connection with IT cartridge 104. IT cartridge 104 may then be brought into contact with docking station 102, in order to allow IT cartridge 104 to receive services from docking station 102. As IT cartridge 104 is brought into contact with docking station 102, rubber sleeve 602 may cover an open portion of IT cartridge 104, thereby protecting the equipment inside IT cartridge 104 from the elements. Rubber sleeve 602 may be angled outward as it extends from docking station 102 (as shown by numeral 604), thereby allowing it to accommodate various different sizes of IT cartridges, while still forming a weatherproof seal. It is noted that the rubber sleeve 602 shown in FIG. 2 may be used with any of the kinds of docking stations and/or IT cartridges shown and described herein, or with any other appropriate designs of docking stations and/or IT cartridges. The use of such a seal is not limited to a docking station having the design shown in FIG. 6.

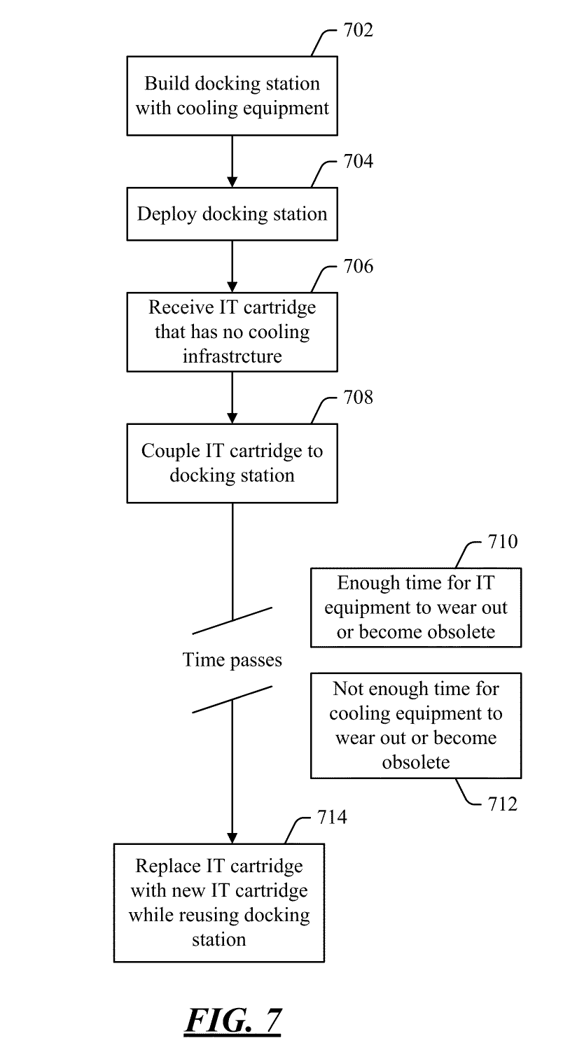

FIG. 7 shows an example process of using IT cartridges with a docking station. At 702, a docking station with cooling equipment is built. The cooling equipment may include, for example, chillers that produce chilled air and/or water, and fans to circulate the cold produced by the chillers. At 704, the docking station is deployed to a location. In one example, the docking station is built on site, in which case the building and deployment of the docking station are the same act (or an intertwined set of acts). In another example, the docking station is built at one location and is moved to a different location for deployment; in that case, the building and deployment of the docking station are separate acts.

At 706, the docking station receives an IT cartridge The IT cartridge may be supplied, for example, by a third party vendor who is distinct from the vendor that owns, operates, and/or builds the docking station. In another example, the IT cartridge is supplied by the owner, operator, and/or builder of the docking station. The IT cartridge that is received may lack cooling equipment and/or a cooling infrastructure to distribute cool liquid. At 708, the IT cartridge is coupled to the docking station. Coupling the IT cartridge to the docking station may be performed using any appropriate techniques and/or structures described above, and/or any appropriate combination of those structures and/or techniques. For example, if the docking station has the structure of docking station 102 (shown in FIG. 1), then coupling the IT cartridge to the docking station may be performed by bringing the IT cartridge up against the docking station, thereby allowing air to flow from the fans of the docking station into the plenum of the IT cartridge. The act of bringing the IT cartridge up against the docking station may be performed using tracks (as shown in FIG. 2), and weather elements may be sealed out using a rubber seal (as shown in FIG. 6). In another example, the docking station may have the structure of docking station 302 (shown in FIG. 3), in which case coupling the IT cartridge to the docking station may involve pulling the IT cartridge into a bay of the docking station using a truck. A rubber seal may close over the opening of the bay when the IT cartridge is in its fully inserted position, thereby keeping weather elements out of the docking station and/or IT cartridge. Additionally, the act of coupling the IT cartridge to the docking station may include plugging the IT cartridge into power and/or network connectivity provided by the docking station.

After the IT cartridge is installed, some amount of time passes. The amount of time that passes is sufficient to allow the IT equipment in an IT cartridge to wear out and/or become obsolete (block 710), but not enough time to allow the cooling equipment in the docking station to wear out or become obsolete (block 712). In one example, the useful life of cooling equipment may be fifteen years, and the useful life of IT equipment may be shorter—e.g., three years. After enough time has passed so that the useful life of the IT equipment has expired but the useful life of the cooling equipment has not, the IT cartridge may be replaced with a new IT cartridge, while reusing the docking station (at 714). In this way, the IT equipment may be disposed of, or otherwise retired, when it has reached the end of its useful life, while allowing the cooling equipment (which may not have reached the end of its useful life) to continued to be used. It is noted that the reuse of the cooling equipment is not mere recycling of the cooling components. In theory, coolers and fans can be uninstalled from one location or component and installed in another location or component; in the techniques described herein, the coolers and fans (and any other appropriate cooling equipment) can be used in place without reconfiguration or relocation, simply by replacing an old IT cartridge with a new IT cartridge. In other words, the equipment in the IT cartridge can be reused; it does not have to be disposed of, and does not even have to be dismantled to allow it to be reassembled in another location or component.

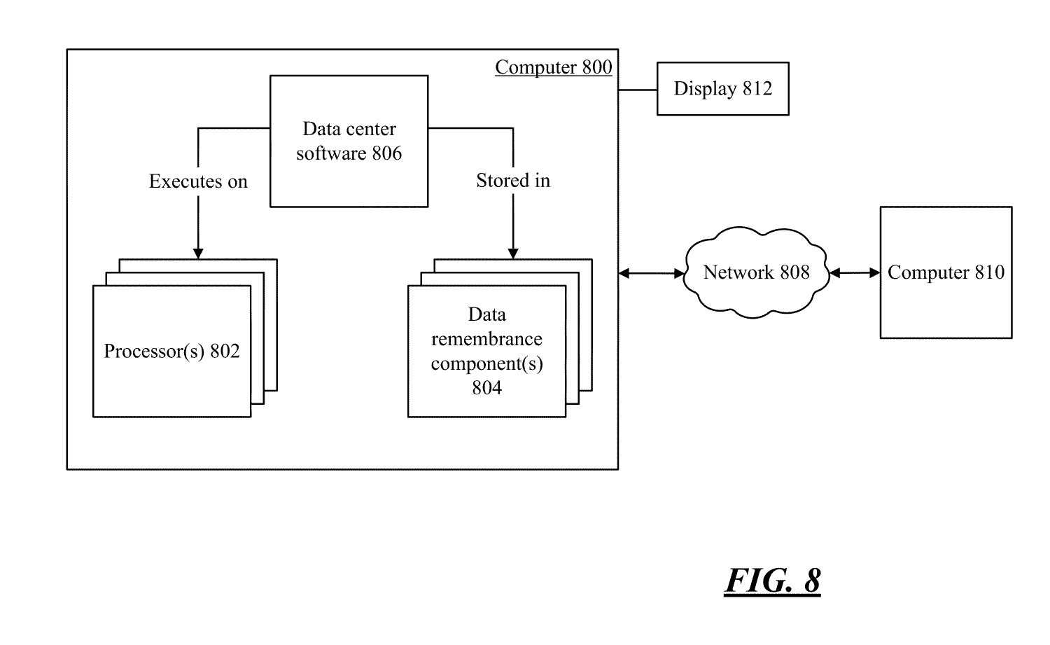

FIG. 8 shows example equipment that may be used with aspects of the subject matter herein. For example, the IT equipment in IT cartridges may be servers or other computing equipment, which may be similar to computer 800 described below, and may be connected to other computers (such as computer 810) as described below.

Computer 800 includes one or more processors 802 and one or more data remembrance components 804. Processor(s) 802 are typically microprocessors, such as those found in a personal desktop or laptop computer, a server, a handheld computer, or another kind of computing device. Data remembrance component(s) 804 are components that are capable of storing data for either the short or long term. Examples of data remembrance component(s) 804 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 800 may comprise, or be associated with, display 812, which may be a cathode ray tube (CRT) monitor, a liquid crystal display (LCD) monitor, or any other type of monitor.

Software may be stored in the data remembrance component(s) 804, and may execute on the one or more processor(s) 802. An example of such software is data center software 806, which may implement some or all of the functionality described above in connection with FIGS. 1-7, although any type of software could be used. Software 806 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 8, although the subject matter described herein is not limited to this example.

The subject matter described herein can be implemented as software that is stored in one or more of the data remembrance component(s) 804 and that executes on one or more of the processor(s) 802. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 802) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 800 may be communicatively connected to one or more other devices through network 808. Computer 810, which may be similar in structure to computer 800, is an example of a device that can be connected to computer 800, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A docking station comprising:
an outer shell;
a cooling apparatus that has a first lifespan;
a fan; and
an opening that detachably receives a cartridge that contains servers, said cartridge having a plenum through which said fan moves air to or from said cooling apparatus, said cartridge not having an infrastructure to distribute chilled liquid through said cartridge, said servers being cooled in said cartridge solely by action of said fan and said cooling apparatus in said docking station, said servers having a second lifespan that is shorter than said first lifespan.

2. The docking station of claim 1, said cartridge being coupled to said docking station by being brought next to said docking station with said plenum of said cartridge being open to said opening of said docking station to allow air to flow between said docking station and said plenum.

3. The docking station of claim 2, said opening having a sleeve into which said cartridge is insertable, said sleeve accommodating different sizes of cartridges and protecting equipment in said cartridge and said docking station from weather elements.

4. The docking station of claim 1, said docking station having a bay, said cartridge being coupled to said docking station by being driven by truck into said bay.

5. The docking station of claim 1, said docking station having a track along which said cartridge moves into a position in which said cartridge is coupled to said docking station.

6. The docking station of claim 1, said cartridge being a shipping container that contains said servers.

7. The docking station of claim 1, further comprising:
a network connection; and
a power connection, said cartridge having a power cable and a data cable, said cartridge receiving power for said servers by having said power cable plugged into said power connection, said cartridge receiving data connectivity for said servers by having said data cable plugged into said network connection.

8. A data center comprising:
a docking station that comprises a cooling apparatus having a first lifespan, a fan, and an opening; and
a cartridge that comprises servers, said cartridge being detachably couplable to said docking station through said opening, said cartridge not having an infrastructure to distribute chilled liquid through said cartridge, said servers being cooled in said cartridge by action of said fan and said cooling apparatus in said docking station, said servers having a second lifespan that is shorter than said first lifespan.

9. The data center of claim 8, said cartridge comprising a plenum through which air moves, said fan moving air to or from said cooling apparatus through said plenum, said fan being positioned to move said air through said plenum when said cartridge is coupled to said cartridge without there being any mechanism in said cartridge that moves said air other than fans in said servers.

10. The data center of claim 8, said docking station comprising a rubber sleeve into which said cartridge is insertable, said rubber sleeve accommodating different sizes of cartridges and protecting equipment in said cartridge and said docking station from weather elements.

11. The data center of claim 8, said docking station comprising a bay, said cartridge being coupled to said docking station by being driven into said bay by a vehicle.

12. The data center of claim 8, said docking station having a track along which said cartridge moves into a position in which said cartridge is coupled to said docking station.

13. The data center of claim 8, said cartridge being a shipping container that contains said servers.

14. The data center of claim 8, said docking station further comprising:
a network connection; and
a power connection, said cartridge having a power cable and a data cable, said cartridge receiving power for said servers by having said power cable plugged into said power connection, said cartridge receiving data connectivity for said servers by having said data cable plugged into said network connection.

15. A method of operating a data center, the method comprising:
deploying a docking station to a location at which said data center is to be operated, said docking station comprising a cooling apparatus and a fan, said cooling apparatus having a first lifespan, said docking station further comprising a data connection, said docking station further comprising electrical-power-providing equipment that serves a power connection;
receiving a first cartridge at said docking station, said first cartridge comprising a plurality of first servers, said first cartridge not having an infrastructure to distribute chilled liquid through said first cartridge, said first servers being cooled in said first cartridge solely by action of said fan and said cooling apparatus in said docking station, said first servers having a second lifespan that is shorter than said first lifespan;
coupling said first cartridge to said docking station; and
replacing said first cartridge with a second cartridge at a point in time at which said second lifespan of said first servers has expired and in which said first lifespan of said cooling apparatus has not expired, said second cartridge comprising a plurality of second servers, said replacing of said first cartridge with said second cartridge being performed without said cooling apparatus in said docking station being disposed of or dismantled.

16. The method of claim 15, said coupling of said first cartridge to said docking station comprising:
bring said first cartridge next to said docking station with a plenum of said first cartridge being open to an opening of said docking station to allow air to flow between said docking station and said plenum.

17. The method of claim 15, an opening of said docking station having a rubber sleeve into which said first cartridge is insertable, said rubber sleeve accommodating different sizes of cartridges and protecting equipment in said first cartridge and said docking station from weather elements.

18. The method of claim 15, said docking station having a bay, said first cartridge being coupled to said docking station by being pulled by truck into said bay.

19. The method of claim 15, said docking station having a track along which said first cartridge moves into a position in which said first cartridge is coupled to said docking station.

20. The method of claim 15, said first cartridge being a shipping container that contains said first servers.
